(19) United States
(12) Patent Application Publication
(10) Pub. No.: US 2008/0004021 A1
(43) Pub. Date: Jan. 3, 2008

(54) Seamless base station / set top box handoff

(76) Inventor: Addicam V. Sanjay, Chandler, AZ (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/479,313

(22) Filed: Jun. 30, 2006

(51) Int. Cl. H04Q 7/20

(52) U.S. Cl. 455/436

(57) ABSTRACT

Various techniques are illustrated and discussed for transferring a communication task, such as a data download, interactive data access, etc., from a first base station to a second base station to accommodate movement of the portable device within a particular environment. Base stations include machines such as set top box (STB), access points, as well as any other device operable to provide data and/or services to the portable device. The phrase “portable device” broadly refers to any device that may easily change location, such as handheld devices including portable computers, personal digital assistants (PDAs) and the like.

### FIELD OF THE INVENTION

The invention generally relates to mobile device communication with set top boxes or other data access points within an environment, and more particularly to maintaining a communication task while a mobile device roams between multiple set top boxes in the environment.

### BACKGROUND

As “digital homes” “digital offices” and other “digital” environments become prevalent, it is increasingly important to facilitate introduction of devices, such as consumer devices and other devices, into these digital environments. However, a digital environment spanning a large area, such as a house, may have several different regions in which a device may be operated, each region typically having a base station or set top box with which devices may interoperate within that region. In this description and claims that follow, the phrase “base station” will be used to generally reference set top boxes such as typically associated with a television, a digital media server (DMS), or other base stations or other devices providing services to devices within a digital environment.

For example, in a digital home, each room may have a base station, such as a set top box adjacent a television, where the base station may be providing services, such as video services, music services, etc. to devices in its region of the digital environment. It will be appreciated that devices may physically connect to the base station, or assuming an appropriately configured base station, devices may establish a wireless connection with the base station. Unfortunately, one significant limitation of conventional digital environments for wireless devices is that a portable device, after associating itself with the base station in its region and starting to receive services from the set top box, if the portable device moves out of range of its associated base station, it will lose its services even if there is another set top box available to provide similar services to the portable device.

The problem, in part, is that even though certain communication techniques, such as wireless protocols conforming to the IEEE (Institute of Electrical and Electronics Engineers) 802.11x family of protocols, e.g., “Wi-Fi”, may provide roaming or handoff between base stations as a portable device changes position with respect to the base stations, there is no corresponding provision for relocating ongoing services between base stations along with the handoff of communication. Such loss in service incident to portable device movement within a digital environment makes it difficult for portable devices to move freely throughout the digital environment.

### BRIEF DESCRIPTION OF THE DRAWINGS

The features and advantages of the present invention will become apparent from the following detailed description of the present invention in which:

FIG. 1 illustrates a system according to one embodiment in which a digital environment has multiple base stations and a portable device therein has a strong connection with a first base station and a weak or non-existent connection with a second base station.

FIG. 2 illustrates a system according to FIG. 1 in which the portable device has moved within the digital environment and now has a strong connection with the second base station and a weak or non-existent connection with the first base station.

FIG. 3 illustrates a flowchart according to one embodiment for handing off communication with a portable device from a first base station to a second base station while maintaining a communication task between the portable device and the first base station.

FIG. 4 illustrates a process flow diagram according to an embodiment illustrating custom Universal Plug and Play (UPnP) function calls.

FIG. 5 illustrates a suitable computing environment in which certain aspects of the invention may be implemented.

### DETAILED DESCRIPTION

Disclosed are various techniques for transferring a communication task, such as a data download, interactive data access, etc., between a portable device and a base station, e.g., a set top box (STB), access point, or other device operable to provide data and/or services to the portable device. It will be appreciated the phrase “portable device” is intended to broadly refer to any device that may easily change location, such as handheld devices including portable computers, personal digital assistants (PDAs) and the like. Other devices and machines are also discussed below.

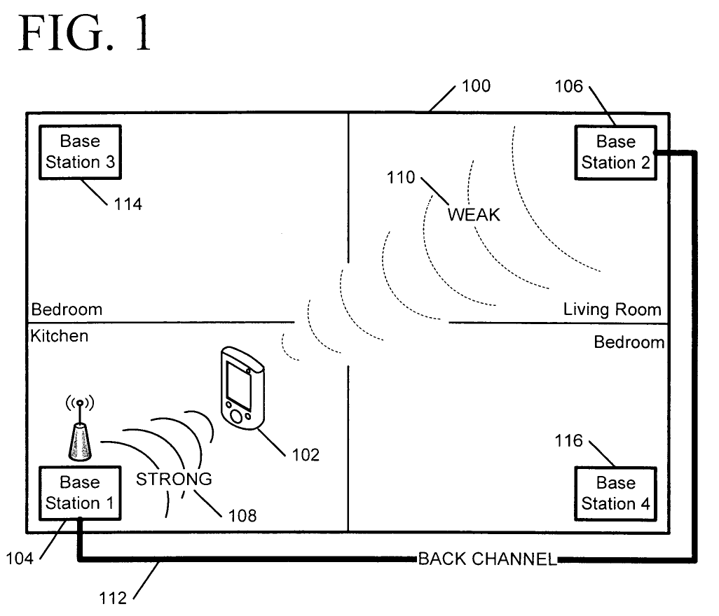

FIG. 1 illustrates a system according to one embodiment in which a digital environment 100 has multiple base stations 104, 106, 114, 116, and a portable device 102 therein has a strong connection 108 with a first base station 104 and a weak or non-existent connection 110 with a second base station 106. In the illustrated embodiment, it is presumed the portable device has established an ad-hoc connection with the first base station.

As will be appreciated, digital environments may have multiple base stations and hence the portable device may have multiple connection options to multiple base stations with various levels of quality for the connection options, and connections may be acquired and/or dropped based on movement of the portable device with respect to the base stations. In particular, it will be appreciated that as a portable device 102 moves away from a base station to which it is associated, e.g., base station 104, signal strength will decrease, and communication quality will deteriorate, resulting in increased network re-transmissions, delayed communication, and interference with data transfer activities, such as slowing down data downloads, causing video images to lose frames, causing audio to skip, data downloads to intermittently fail, and the like.

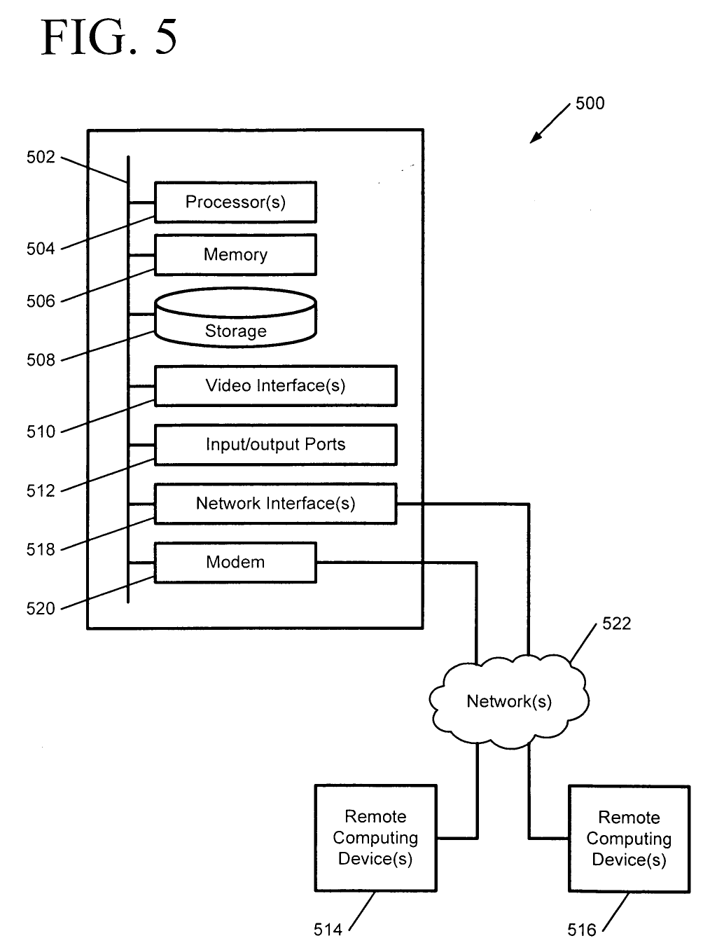

In an effort to overcome such problems with a portable device 102, disclosed embodiments concern providing for device handoff between base stations 104, 106, 114, 116 including transferring content and/or content related communication tasks to a base station having a stronger wireless signal than a current base station associated with or otherwise being used to communicate with the portable device, e.g., as will be discussed further with FIG. 5, the portable device may be any device that may move with respect to a base station, but for expository convenience it is assumed the portable device is something akin to a handheld personal digital assistant, tablet type computer, laptop/notebook computer, or the like. It will be appreciated handoff of content and/or related communication task(s) will facilitate improved data access and/or downloads, improve jerky video images, improve audio quality, etc.

In the illustrated embodiment 100, it is assumed the portable device 102 maintains an ad-hoc wireless connection with one or more base stations 104, 106, 114, 116, such as in a digital home or digital office type of environment. It will be appreciated the base station may also operate as an “access point” for a portable device, however the present invention is general and an access point is not required. Base stations may be a variety of devices, as discussed in more detail below, such as Set Top Boxes (STBs), or PVR's (Personal Video Recorders), television tuners, television adapters or converters, etc., each inter-connected with Ethernet or an other network. Base stations may be configured to as a multi-purpose media center personal computer (PC), or other device or device collective operating to control, store and/or serve digital content to other devices, such as an audio and/or video system, home theater, etc.

Various wired or wireless technologies may be used to communicatively couple the portable device 102 with other devices within the environment 100, such as through use of one of the IEEE LAN/MAN Standards Committee standards, for example, a protocol in accord with one of the IEEE 802.x family of wired or wireless communication protocols, a short-range radio technology such as Bluetooth, or Zigby, a specification for communication protocols using small, low-power digital radios based, for example, on the IEEE 802.15.4 standard for wireless personal area networks (WPANs) enabling reliable, cost-effective, and low-power wireless device networking, monitoring and control. It will be appreciated these are simply a few exemplary technologies utilizable to interconnect selected devices within the environment 100.

A digital home, digital office, etc. environment 100 may contain a wide variety of devices that can store, access and play different forms of digital media with device control intelligence distributed throughout the environment. Sophisticated controllers and controlling applications, e.g., software, special purpose hardware, e.g., an application specific integrated circuit (ASIC), general purpose hardware, e.g., a programmable gate array (PGA), etc., may coordinate behavior of network devices. For example, an intelligent platform such as a PC, advanced set-top box, digital TV, networked control pad, Personal Digital Assistant (PDA), telephones, wireless monitors, game consoles, digital media adapter (DMA), etc. may manage and distribute rich digital content from devices such as digital video recorders (DVRs), digital cameras, network DVD players, multimedia mobile phones, etc. to other devices such as televisions, stereos, wireless speakers, monitors, and the like.

The base stations 104, 106, 114, 116, are expected to provide a wireless capability for communication with the portable device(s) 102, as well as another communication path, either wireless or wired for communication between them, e.g., back channel 112. In one embodiment, various levels of service may be provided based on the nature of the devices involved. For example, premium capabilities, added throughput, more options, etc. may be available when both the portable device and a base station are provided by the same vendor, while perhaps only standard features are available between devices of different vendors.

The illustrated embodiment may operate in accord with the Digital Living Network Alliance (DLNA). The DLNA is an alliance of companies in the mobile, consumer electronics, personal computer, etc. industries promoting industry standards for interoperability of products from different companies, and to facilitate a network of such devices in a home environment. Companies operating in accord with the alliance remain able to innovate and differentiate their own products. Assuming the environment 100 a DLNA type of environment, there are multiple categories of devices that may interoperate and be used in accord with the teachings herein.

For example DLNA includes a Home Network Device (HND) category including a DMS, DMP, DMR, and DMPr. A DMS provides media acquisition, recording, storage, sourcing capabilities, etc., as well as content protection enforcement as required, and may include Digital Media Player (DMP) capabilities or work with a DMP. A DMP finds and utilizes content exposed by a DMS and may be any of a variety of devices. A Digital Media Renderer (DMR) manipulates and/or plays content received after setup by another network entity. A DMR may be, for example, an audio/video receiver, video monitor, remote speakers, etc. A Digital Media Controllers (DMC) finds or utilizes content exposed by a DMS and matches it against rendering capabilities of a DMR, setting up the connections between the DMS and DMR. A Digital Media Printer (DMPr) provides printing services to devices in the DLNA environment.

Another DLNA category is the Mobile Handheld Device (MHD) category including the M-DMS, M-DMP, M-DMU, M-DMD, M-DMC. The Mobile Digital Media Server (M-DMS) devices, such as a mobile phone and a portable music player, expose and distribute content. A Mobile Digital Media Player (M-DMP) find or utilizes content exposed by a M-DMS, such as to play content locally on a M-DMP. A Mobile Digital Media Uploader (M-DMU) device, such as a camera, sends content to an M-DMS. A Mobile Digital Media Downloader (M-DMD) device finds and acquires content exposed by an M-DMS. A Mobile Digital Media Controller (M-DMC) device finds content exposed by an M-DMS and matches it to rendering capabilities of a DMR and establishes connections between the media server and renderer.

It will be appreciated there are other DLNA and DLNA-type device categories not discussed. And, while DLNA embodiments have specific meanings as defined within the DLNA, it will be appreciated the DLNA principles may be generally practiced by the disclosed embodiments without the limitations and/or restrictions inherent to DLNA. However, in a DLNA environment, as discussed above, one may offer special features or added functionality for devices from a same vendor or related vendors as an inventive to consumers to seek devices from a vendor or vendors from which special features or functionality may be obtained.

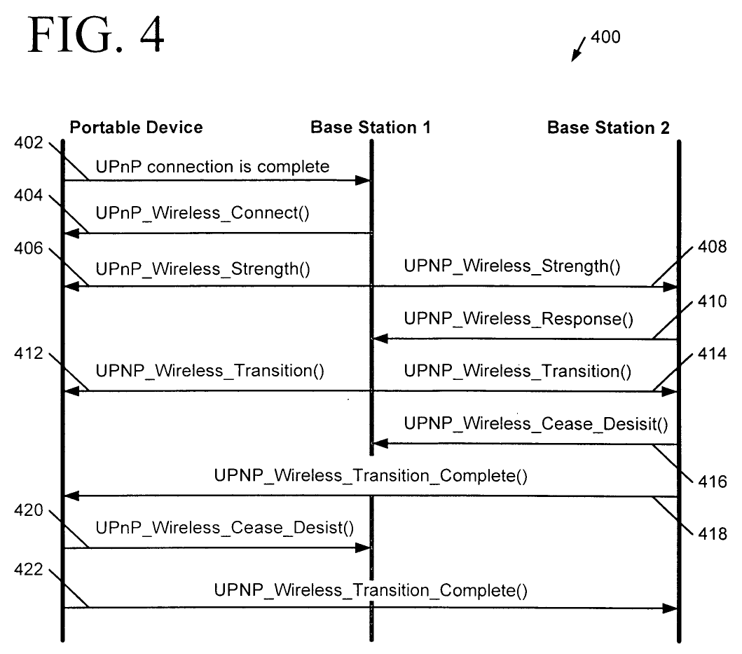

As will be appreciated, any variety of DLNA and other devices may be present within the digital environment 100. As illustrated in FIG. 1, the portable device 102 has a strong 108 connection with base station 104 in the kitchen. However, if the portable device may move to a spot such that the signal strength and/or quality of signal between the portable device and base station may decrease. In the illustrated embodiments, the kitchen base station 104 periodically or continuously monitors the strength of the wireless signal 108 with the portable device. If the Strength of the signal decreases below a predetermined level, then the base station 104 starts searching for another base station in the digital environment 100 which may have a better wireless signal with the Handheld device. As will be discussed with respect to FIG. 4, UPnP techniques may be used to manage devices within the digital environment. UPnP defines, for example, Quality of Service functions for monitoring operation quality, and such quality monitoring functions, or other such functions, may be used herein.

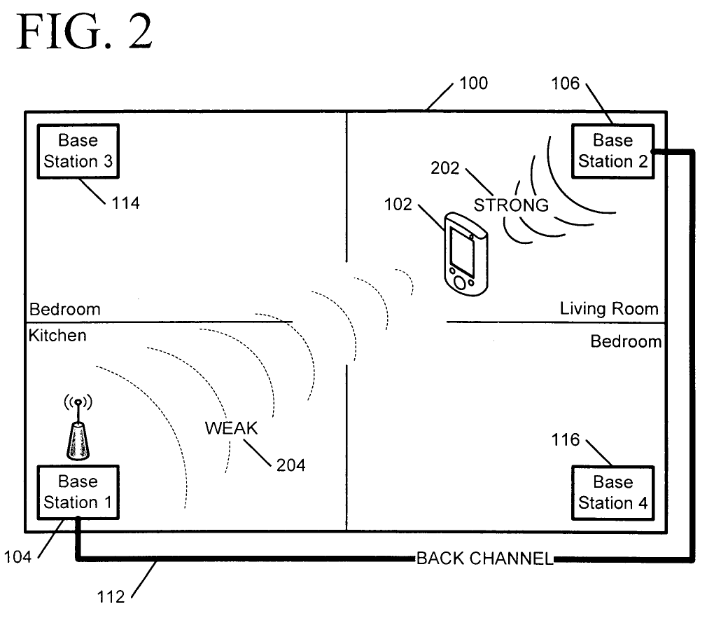

FIG. 2 illustrates a system 200 according to FIG. 1 in which the portable device 102 has moved within the digital environment 100 and now has a strong connection 202 with the second base station 106 and a weak or non-existent connection 204 with the first base station 104. As in FIG. 1, it is assumed the portable device has established an ad-hoc connection with the second base station.

As noted above, it is assumed the portable device 102 has moved away from the first base station 104 and closer to the second base station 106. As will be discussed in detail with respect to FIG. 4, the portable device has established connections with the base stations 104,106, etc. using UPnP type commands. The second base station 106 is configured to respond to a search request performed by the first base station regarding whether another base station has a better connection, e.g., whether the second base station 106 has a better communication with the portable device 102. It is assumed (but not required) that the base stations 104, 106, 114, 116 have a back channel 112, e.g., Out of Band (OOB) or other wired or wireless communication path over which data and/or signaling such as comparing connection 108, 110, 202, 204 strengths may be compared.

Thus, assuming the portable device 102 starts a data transfer over FIG. 1 strong connection 108, such as streaming media files and/or data such as movies or music to the portable device, while the strength of the wireless signal is pretty strong, the data transfer will proceed smoothly without unnecessary retransmissions. However, as the portable device moves away from the kitchen base station 104, the signal strength may decrease. As discussed above, assuming a wireless connection with the portable device, the base station 104 monitors the signal strength and/or quality with the portable device, and if it falls below a desired strength and/or quality level, the base station starts looking for another base station that may have better communication with the portable device. In the illustrated embodiment, the portable device has moved in to the living room portion of the digital environment 100 and hence the portable device now has a strong connection 202 with the base station 106 and a weak connection 204 with the base station 104.

In the illustrated embodiment, at some point the portable device 102 has overlapping connections with both base stations 104, 106, and it has been determined the portable device appears to be moving out of range of the kitchen base station. While the portable device has both connections 202, 204, the kitchen base station searches for another base station with a better connection, e.g., the living room base station 106 with connection 206, so that the kitchen base station may seamlessly hand off communication with the portable device to the other base station. In the illustrated embodiment, the kitchen base station queries the other base stations in the environment 100, e.g. stations 106, 114, 116; the living room base station 106 is identified as having the best available connection with the portable device.

Once the kitchen base station is identified, the kitchen and living room base stations 104, 106 and the portable device 102 negotiate to transfer the state of ongoing communication tasks between the portable device and the kitchen base station to the living room base station. Such negotiation is discussed below in detail with respect to FIG. 4.

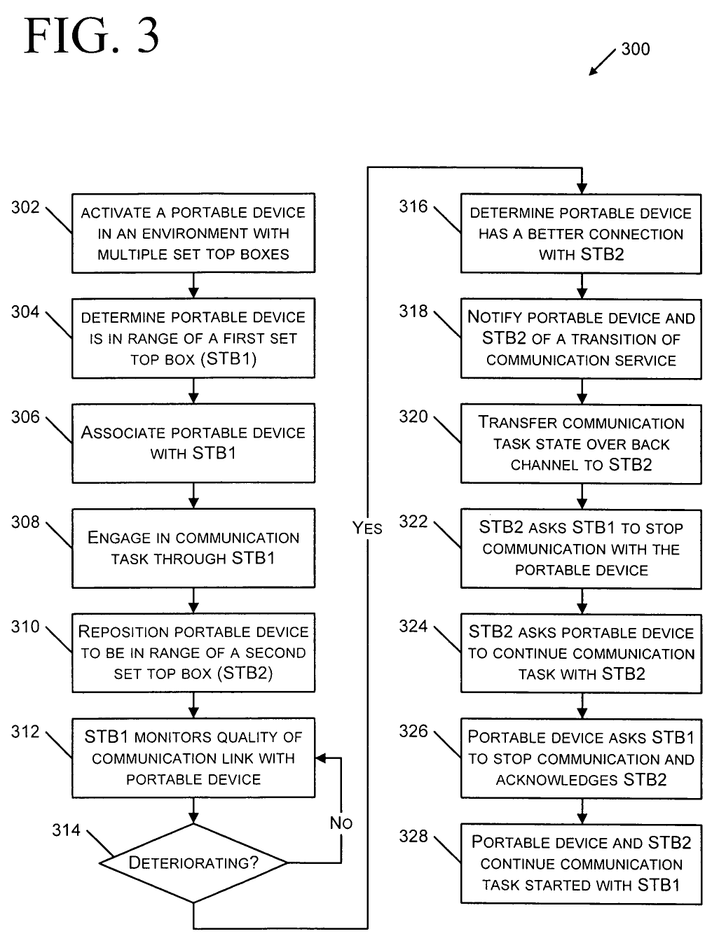

FIG. 3 illustrates a flowchart 300 according to one embodiment for handing off communication with a portable device from a first base station to a second base station while maintaining a communication task established between the portable device and the first base station.

Assuming an environment such as the FIG. 1 environment 100, as illustrated a first operation is to activate 302 a portable device 102, such as a tablet-based computing device or computer, music player, video player, game console, etc. Note that while the illustrated embodiments assume a distinction in roles between the base stations 104,106,114,116, the portable device 102 and other devices that may be present in the environment, it will be appreciated that the devices may encompass multiple classes of device, e.g., a portable device may have sufficient resources to both act as a server of resources as well as a client consuming services from other servers. It will be further appreciated that activating 302 the portable device may represent a variety of actions including, by way of example only, powering on the device, changing a power state of the device, e.g., waking up from a sleep or hibernation mode, starting or speeding up a processor of the device, activating or configuring communication features of the portable device so it may communicate with base stations, etc.

After activating 302 the portable device, the device searches for base stations to which it may communicate in the illustrated embodiment, the portable device identifies 304 a first Set Top Box (STB1) in range, and associates 306 with STB1. Identification 304 may reveal other devices within the environment, such as base stations 104, 106, 114, 116, however it will be appreciated in such circumstance STB1 will be deemed as being the device with the strongest connection. Once associated with STB1, the portable device may start a communication task, such as streaming music to the portable device from a music service available either locally and/or over the Internet from free and for-fee services. The portable device may be configured with a variety of e-commerce capabilities as needed to acquire data to stream to the device. This streaming of music represents a communication task between the portable device and STB2. Since the device is portable, however, the STB1 monitors 312 quality of communication with the portable device for deterioration or degradation.

If 314 communication does not appear to be deteriorating, then in the illustrated embodiment, processing logically continues with monitoring 312 the communication. It will be appreciated that many other operations not illustrated may be performed before or in parallel with continuing back to monitoring as illustrated. If communication does appear to be deteriorating, then as discussed above STB1 will search the environment for another device having better, e.g., faster, stronger signal, better quality of service, etc., communication with the portable device. As illustrated, through querying other devices within the environment, the STB1 determines a second Set Top Box (STB2) has better communication with the portable device.

Before the portable device loses its connection to STB1, STB1 notifies 318 both the portable device and STB2 of a desire to transfer the communication task from STB1 to STB2. As needed, such a transfer includes transferring 320 any state data corresponding to the task, e.g., position in song being streamed or other data relating to the communication task needed for the STB2 to synchronize state with the STB1 and seamlessly continue the communication task in the place of STB1. In the illustrated embodiment, it is assumed a back channel is used to effect the transfer, such as a fast wired network, however with continuing advances in wireless technology range and performance, it will be appreciated a separate wireless communication path may be used. Once state has been transferred, the STB2 asks 322 the STB1 to stop communication with the portable device, and asks 324 the portable device to continue the communication task with STB2. To ensure a seamless handoff between STB1 and STB2, the portable device acknowledges the transfer by asking 326 the STB1 to stop the communication task and acknowledges the transfer to STB2.

In such fashion, since communication state is transferred 320, as needed, the portable device may continue 328 its communication task, e.g., music playing, etc., with STB2, while in the background the Set Top Boxes servicing the task may change as the portable device moves about the digital environment. It will be appreciated by one skilled in the art various buffering and synchronization techniques may be used to ensure data streaming from STB2 picks up at precisely the correct moment so that hand off is not detectable. In an alternate embodiment not illustrated, a state server may be disposed within the environment where its role at least in part is to receive and maintain communication task state for the STB1 or other devices within the environment. Such a state server may be used to transfer state between STB1 and STB2, even if the portable device has moved out of range of STB1 before the illustrated hand off can be accomplished. With protocols providing adequate buffering or other configuration safe guards, hand off may remain seamless even through use of the state server.

FIG. 4 illustrates a process flow diagram 400 according to an embodiment illustrating custom Universal Plug and Play (UPnP) function calls, e.g., functions in accord with UPnP but not (yet) part of any UPnP based standard. In this embodiment, UPnP is used as the underlying mechanism for communication task handoff. UPnP is extended to include a basic set of functions to allow various base stations and portable devices to discover each other and establish connections with each other. UPnP is convenient because it is the protocol currently underlying DLNA and hence may easily integrate with its basic infrastructure. It will be appreciated, however, that the teachings disclosed herein may be adapted as desired to other programming environments and constructs.

In the illustrated embodiment, monitoring of signal strength and/or communication quality between a portable device and base station cannot be done by existing UPnP calls. Thus the illustrated custom UPnP calls are defined and discussed with respect to the illustrated flow diagram. It will be appreciated the following is not intended to represent a complete set of custom UPnP calls. In the illustrated embodiment, the custom UPnP calls are executed roughly in chronological order down the flow diagram and roughly correspond to the operations discussed above with respect to FIG. 3.

After a Portable Device has completed 402 its connection within a digital environment, e.g., the devices has been activated and successfully associated with a base station, e.g., Base Station 1, the Portable Device may issue a UPnP_Wireless_Connect( ) function call 404. This call is used to notify UPnP devices that are monitoring for such connections, such as Base Station 2, to be aware that a communication connection was established for transferring data, e.g., as part of a communication task as discussed above, and that some device connectivity changes may occur if connection strength and/or quality of the connection deteriorates. As will be appreciated, while UPnP devices may employ point-to-point as well as peer-to-peer (P2P) communication within a environment, for expository convenience it is assumed ad hoc wireless connections are established and P2P UPnP is utilized to communicate between the Portable Device and other devices within the environment.

After the Portable Device is connected 404, the base station to which it is associated monitors, see e.g., FIG. 3 item 312, for deterioration in the communication link between the Portable Device and its associated base station. If a problem is identified, then the UPnP_Wireless_Strength( ) function call may be used to test for deterioration and query other devices in the environment for the status of their connection to the Portable Device. For example, in the illustrated embodiment, this function call may be used 406 by Base Station 1 to inform the Portable Device that communication signal strength is deteriorating, e.g., a wireless signal strength is weakening such as incident to movement of the Portable Device, and use of the call by Base Station 1 may also inform 408 interested devices such as Base Station 2 that Base Station 1 is seeking to hand off the Portable Device to another base station.

It will be appreciated in one embodiment the UPnP_Wireless_Strength( ) function calls 406, 408 represent a single broadcasted call received by all devices in the environment, e.g., over the wireless communication medium employed by the Portable Device; in another embodiment, the calls 406, 408 represent two different calls made on two different communication mediums, e.g., call 406 over the wireless communication medium employed by the Portable Device and call 408 over a back channel, see, e.g., FIG. 1 item 112. It will also be appreciated that for a wireless connection, there are many different algorithms that may be used to calculate a desirable wireless signal strength, and hence a threshold under which communication deterioration is concluded and Base Station 1 seeks to locate another base station for handling the Portable Device's ongoing and/or future communication task(s).

The UPnP_Wireless_Respons( ) function call 410 is used by Base Station 2 responsive to the UPnP_Wireless_Strength function call(s) 406, 408. This call may be used by Base Station 2 to indicate it has a strong communication connection with the Portable Device, e.g., to signify a strong wireless signal and/or high quality of service associated with communication with the Portable Device. Also incorporated into this call are transfer operations, as needed, to transfer the state of any communication tasks occurring between the Portable Device and Base Station 1 over to Base Station 2. As discussed above, for convenience, this state transfer is expected to occur over a separate communication link such as the back channel 112 of FIGS. 1-2. In one embodiment, state transfer includes Base Station one providing Base Station 2 with a link, e.g., a URI/URL (Uniform Resource Identifier/Locator) to a resource stored by Base Station 1 or hosted external thereto, and meta-data, such as an index or offset into the resource (if needed) so Base Station 2 may continue the communication task with the Portable Device. In one embodiment, if Base Station 1 has previously acquired data to be provided to the Portable Device, this data is transferred to Base Station 2 along with whatever data or meta data may be required to allow Base Station 2 to seamlessly continue a communication task initiated with Base Station 1.

The UPnP_Wireless_Transition( ) function call 412, 414 is used after the base station associated with the Portable Device receives a UPnP_Wireless_Respons( ) 410 identifying another base station with better communication with the Portable Device. As illustrated, this call is issued 412 by Base station 1 to the Portable Device to inform it that the Portable Device's communication task will be transferred to a new communication link with Base Station 2, and that the Portable Device should prepare for the transfer. Assuming the Portable Device has wireless point-to-point connection with base stations, transitioning to Base Station 2 may require the Portable Device to establish a new communication path with Base Station 2 and take other action as needed to take the transfer, e.g., the portable device may elect to buffer more data temporarily to carry it through the transition to Base Station 2. This function call may also be issued 414 by Base Station 1 to Base Station 2 to inform it that it has the best communication link with the Portable Device and hence Base Station 2 should establish the new communication path with the Portable Device and continue the current communication task, e.g., continue streaming data, performing a download, etc. In one embodiment, the Portable Device initiates this new communication path; in another embodiment, Base Station 2 initiates the new communication path responsive to receiving the UPnP_Wireless_Transition( ); in a still further embodiment, both the Portable Device and Base Station 2 attempt to contact the other to establish the new communication path in accord with a handshaking technique.

The UPnP_Wireless _Cease_Desist( ) function is used by base stations and portable devices to acknowledge receipt of the transfer request by a base station associated with a portable device. Thus, for example, after Base Station 2 receives the UPnP_Wireless_Transition( ), it calls 416, e.g., over a back channel, the UPnP_Wireless_Cease_Desist( ) to inform Base Station 1 that Base Station 2 has understood the transition call 414 and will establish the new communication path with the Portable Device, e.g., via a wireless or other connection technique. Responsive to the call 416, Base Station 1 transfers the current communication task(s) with the portable device and associated state, meta data, etc. over a back channel (see, e.g., FIG. 3 discussion above) communicatively coupling Base Stations 1 and 2. In one embodiment, after receiving this function call, Base Station 1 stops active communication with the Portable Device. This function may also be called 420 by the Portable Device to indicate to Base Station 1 that it understands the communication task(s) with Base Station 1 are going to be handed off to another base station as discussed with respect to the other figures.

In one embodiment, Base Station 1 does not establish active future connections with Portable Device unless signaled to do so by another base station, e.g., responsive to a UPnP_Wireless_Strength( ) function call. In another embodiment, base stations attempt to establish idle communication paths with portable devices within range to facilitate quickly transferring communication tasks and associated state, meta data, etc., between the base stations. In yet another embodiment, only base stations such as Base Station 1 having a previous active communication with the Portable Device maintain idle communication paths to allow for situations where the Portable Device has only temporarily moved towards another base station, and then returned. For example, such a situation may occur when a device associated with a base station in a living room may, for example, be carried into the kitchen during a commercial break and then returned to the living room. In such a situation as applied to the illustrated embodiment, Base Station 1 maintains an idle communication path with the Portable Device to facilitate its resuming the communication task after the Portable Device moves back towards Base Station 1.

After Base Station 2 calls 416 the UPnP_Wireless _Cease_Desist( function call, it may call 418 the UPnP_Wireless_Transition_Complete( ) function to notify the Portable Device (and any other UPnP aware devices that are interested) to notify the Handheld device that Base Station 2 has established communication, e.g., a wireless connection or other communication link, with the Handheld device and Base Station 2 is now ready to continue the communication task with the Portable Device. This function may also be called 422 by the Portable Device to notify Base Station 2 that the Portable Device is ready to continue its communication tasks with Base Station 2. As discussed above, various buffering and/or synchronization techniques may be employed to ensure the handoff avoids interruption of the communication task(s).

FIG. 5 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc.

Typically, the environment includes a machine 500 that includes a system bus 502 to which is attached one or more single or multiple-core processors 504, a memory 506, e.g., random access memory (RAM), read-only memory (ROM), or other state preserving medium, storage devices 508, a video interface 510, and input/output interface ports 512. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 514, 516, such as through a network interface 518, modem 520, or other communicative coupling. Machines may be interconnected by way of a physical and/or logical network 522, such as the FIG. 1 and FIG. 2 wireless 108, 110, 202, 204 links and back channels 112, an intranet, the Internet, local area networks, and wide area networks. One skilled in the art will appreciated that communication with network 522 may utilize various wired and/or wireless short range or long range carriers and protocols, including radio frequency (RF), satellite, microwave, IEEE 802.11, Bluetooth, optical, infrared, cable, laser, etc.

The invention may be described by reference to or in conjunction with associated data such as functions, procedures, data structures, application programs, etc. which when accessed by a machine results in the machine performing tasks or defining abstract data types or low-level hardware contexts. Associated data may be stored in, for example, volatile and/or non-volatile memory 506, or in storage devices 508 and/or associated storage media, including conventional hard-drives, floppy-disks, optical storage, tapes, flash memory, memory sticks, digital video disks, etc., as well as more exotic mediums such as machine-accessible biological state preserving storage. Associated data may be delivered over transmission environments, including network 522, in the form of packets, serial data, parallel data, propagated signals, etc., and may be used in a compressed or encrypted format. Associated data may be used in a distributed environment, and stored locally and/or remotely for access by single or multi-processor machines. Associated data may be used by or in conjunction with embedded controllers; hence in the claims that follow, the term “logic” is intended to refer generally to possible combinations of associated data and/or embedded controllers.

Thus, for example, with respect to the illustrated embodiments, assuming machine 500 embodies the portable device 102 of FIG. 1, then remote machines 514, 516 may respectively be FIG. 1X base stations 104, 106. It will be appreciated that remote machines 514, 516 may be configured like machine 500, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for set-top box handoff between a first base station communicatively coupled with a second base station, the base stations sharing at least communication quality statistics for devices associated therewith, the method comprising:
determining a first portable device is in wireless communication range with at least the first base station;
associating the first portable device with the first base station and performing a communication session through the first base station, the communication session having a communication quality;
repositioning the first portable device, wherein said repositioning degrades the communication quality with the first base station;
receiving a session transfer notification indicating the first portable device should associate with the second base station; and
associating the first portable device with the second base station and performing the communication session through the second base station without interrupting the communication session previously handled by the first base station.

2. The method of claim 1, wherein the base stations communicate on an out of band channel to relay said at least communication quality statistics, and wherein selected ones of the base stations perform:
monitoring communication quality with the first portable device;
identifying a degradation of communication quality with the first base station; and
determining the second base station has an improved communication quality with the first portable device, and responsive thereto, issuing the session transfer notification.

3. The method of claim 2, wherein a selected one of Universal Plug and Play (UPnP) or Digital Living Network Alliance (DLNA) is utilized to perform selected ones of said issuing the session transfer notification, and said associating the first portable device with the first base station.

4. The method of claim 1, wherein the first base station is a selected one of a digital media player or a digital media server.

5. The method of claim 1, wherein the communication session utilizes a wireless communication channel based at least in part on a selected one or more of an 802.11 protocol, Bluetooth, or Zigby.

6. The method of claim 1 wherein the base stations are disposed at different locations within a residence.

7. The method of claim 1, further comprising:
identifying the first portable device and at least the first base station share a characteristic; and
responsive identifying the shared characteristic, offering an enhanced level of service to the first portable device.

8. The method of claim 7, wherein the enhanced level of service comprises selected ones of a higher communication priority given communication with the portable device, a faster communication rate used to communicate with the portable device, or an advanced communication feature available due to the shared characteristic.

9. A method utilizing first and second base stations sharing communication quality statistics, the method comprising:
associating a portable device with the first base station according to a protocol;
receiving a notification from the first base station that a communication quality with the portable device will be monitored;
receiving a second notification from the first base station to notify at least the portable device and the second base station of a degradation in a first communication quality associated with communication with the portable device;
responsive to the second notification, receiving a third notification from the second base station notifying at least the portable device and the first base station that the second base station has a higher quality communication with the portable device than the first communication quality; and
receiving a fourth notification instructing the portable device to stop communication with the first base station and instead to communicate with the second base station.

10. The method of claim 9, further comprising:
responsive to the fourth notification, instructing the first base station to stop communication with the portable device; and
receiving notification from the second base station of an establishment of communication between the second base station and the portable device.

11. The method of claim 9, wherein said notifications correspond to functions extending the Universal Plug and Play Protocol (UPnP).

12. The method of claim 9, wherein the protocol includes messages sent in accord with the Universal Plug and Play Protocol (UPnP).

13. The method of claim 9, wherein the associated communication quality is based at least in part on a measured signal strength between the portable device and the first base station.

14. The method of claim 9, wherein the associated communication quality is based at least in part on a distance between the portable device and the first base station.

15. An article comprising a machine-accessible medium having one or more associated instructions for set-top box handoff between a first base station communicatively coupled with a second base station, the base stations sharing at least communication quality statistics, wherein the one or more instructions, if executed, results in a machine performing:
determining a first portable device is in wireless communication range with at least the first base station;
associating the first portable device with the first base station and performing a communication session through the first base station, the communication session having a communication quality;
repositioning the first portable device, wherein said repositioning degrades the communication quality with the first base station;
receiving a session transfer notification indicating the first portable device should associate with the second base station; and
associating the first portable device with the second base station and performing the communication session through the second base station without interrupting the communication session previously handled by the first base station.

16. The article of claim 15 wherein the base stations communicate on an out of band channel to relay said at least communication quality statistics, and wherein the machine-accessible media further includes instructions, when executed, results wherein selected ones of the base stations performing:
monitoring communication quality with the first portable device;
identifying a degradation of communication quality with the first base station; and
determining the second base station has an improved communication quality with the first portable device, and responsive thereto, issuing the session transfer notification.

17. The article of claim 15 wherein the first base station is a selected one of a digital media player or a digital media server.

18. The article of claim 15 wherein the machine-accessible media further includes instructions, when executed, results in a machine performing:
identifying the first portable device and at least the first base station share a characteristic; and
responsive identifying the shared characteristic, offering an enhanced level of service to the first portable device.

19. An article comprising a machine-accessible medium having one or more associated instructions for configuring operation of first and second base stations sharing communication quality statistics, wherein the one or more instructions, if executed by the base stations results in one or more of the base stations performing:
associating a portable device with the first base station according to a protocol;
receiving a notification from the first base station that a communication quality with the portable device will be monitored;
receiving a second notification from the first base station to notify at least the portable device and the second base station of a degradation in a first communication quality associated with communication with the portable device;
responsive to the second notification, receiving a third notification from the second base station notifying at least the portable device and the first base station that the second base station has a higher quality communication with the portable device than the first communication quality; and
receiving a fourth notification instructing the portable device to stop communication with the first base station and instead to communicate with the second base station.

20. The article of claim 19 wherein the machine-accessible media further includes instructions, when executed, results in one or more of the base stations performing:
responsive to the fourth notification, instructing the first base station to stop communication with the portable device; and
receiving notification from the second base station of an establishment of communication between the second base station and the portable device.

21. A system comprising:
a first base station including a first transceiver for communication with at least portable devices a second transceiver;
a second base station including a third transceiver for communication with at least portable devices and a fourth transceiver communicatively coupled with the second transceiver to facilitate a back channel over which a communication task state may be transferred so portable devices may roam between base stations and maintain the communication task; and
a portable device including a fifth transceiver for communication with the first and second base stations, the portable device configured to associate with the first base station, engage in the communication task with the first base station, and responsive to movement of the portable device relative to the base stations, to associate with the second base station and seamlessly continue the communication task through the second base station.

22. The system of claim 21,
wherein the base stations exchange over the back channel communication quality statistics for their communication with the portable device, and
wherein a degradation in quality of communication between the first base station and the portable device and an improvement of communication between the second base station and the portable device results in a transfer of the communication task from the first base station to the second base station.

23. The system of claim 21, wherein the portable device and base stations implement selected ones of Universal Plug and Play (UPnP) or Digital Living Network Alliance (DLNA).
